(19) United States
(12) Patent Application Publication
(10) Pub. No.: US 2013/0073094 A1
(43) Pub. Date: Mar. 21, 2013

(54) BUILDING OCCUPANCY DEPENDENT CONTROL SYSTEM

(71) Applicants: Cary Knapton, Swa Zulu Natal (ZA); Paul Collins, Somerset (GB); Barry Webb, Dorset (GB)

(72) Inventors: Cary Knapton, Swa Zulu Natal (ZA); Paul Collins, Somerset (GB); Barry Webb, Dorset (GB)

(73) Assignee: TELEPURE LIMITED, Somerset (GB)

(21) Appl. No.: 13/638,206

(22) PCT Filed: Mar. 30, 2011
(86) PCT No.: PCT/GB2011/000491

§ 371 Date: Dec. 10, 2012

(30) Foreign Application Priority Data
Mar. 30, 2010 (GB) 1005320.5

(51) Int. Cl. G05B 13/02

(52) U.S. Cl. CPC G05B 13/02
USPC 700/278

(57) ABSTRACT

An HVAC control system is described comprising: a server (32) having planned information, a man-machine interface (50) capable of communication with the server (32) to provide dynamic information about building occupancy based on a change in cold water in a mains riser. A central control unit (28) which can communicate with the server (32), and a room node (22, 24) for providing information about conditions within the room whereby, the information about room conditions is compared to planned information and/or dynamic information and adjustments made accordingly. The room node (22, 24) may comprise sensors (276, 278, 272, 274) which provide information about conditions in the room. Dynamic information can include changes to planned occupancy, the effect of solar heating and weather conditions. Changes to planned occupancy can be established through detecting location (internally or externally) or destination of a user; and calculating estimated time of arrival of a user.

### FIELD OF THE INVENTION

This invention relates to a control system, more particularly the invention relates to an improved control system for use in heating, ventilation and air conditioning (HVAC) systems.

### BACKGROUND OF THE INVENTION

Many domestic heating boilers installed in the UK (circa 22 million), including most of the so-called “energy-efficient condensing boilers” not operate at optimal efficiency for only a relatively small amount of the time they are operational. These incumbent systems generally rely upon human intervention in programming a panel that normally works on a seven-day cycle with typically three on/off events throughout each day. This somewhat rigid approach does not adequately take into consideration the dynamic changes of a typical family lifestyle which affects usage of the building. As a consequence such repetitive programmes are wasteful and very efficient.

Domestic heating CO₂ emissions are said to represent one quarter of all UK CO₂ emissions (Source: DEFRA Policy Brief—Improving the energy performance of domestic heating and hot water systems—July 2008). This is a similar level to all UK road transport and is likely to attract increased attention as a source of taxable revenue

An objective of the present invention is to reduce energy usage and hence both fuel cost and CO₂ emissions. Typically, a control system according to the present invention reduces fuel consumption by around 20%; preferably more than 20% reduction is achieved, even on a typical modern condensing boiler and without impacting comfort for householders.

A 20% saving on fuel represents extremely a significant saving from both a cost and environmental perspective. I

### PRIOR ART

Predictive temperature control adaptation has previously been documented in the NEUROBAT research project in 1999 using artificial neural networks to allow the adaptation of the control model to the real conditions (climate, building characteristics) however, the geo-location of a building occupant was not considered.

Weather compensation has formed part of condensing boiler technology for a number of years now in the commercial market place. It has in most cases formed part of the offering of the boiler manufacturer. There is little or no availability of an aftermarket offering for weather compensation in the residential market or boilers rated under 50 KW or so.

Traditional indirect hot water systems work on the basis of heating the water on a timed basis, normally twice a day at set programmed timed intervals. In the same way as room temperature is controlled indirect hot water systems have a thermostat attached to the hot water cylinder. This works in a logic configuration so if both the timer is demanding hot water and the current water temperature is below the set-point then the HVAC runs and the hot water is pumped through the indirect coil within the hot water tank, thus heating the tank of water up. This is extremely inefficient.

International Patent Application WO-A2-2009/036764 (Danfoss A/S) describes and claims a control system for regulating a boiler that includes a position identification device. The position identification device provides data as to the location of a wearer and this data is used to predict the wearer's behaviour and so optimise management of the control system.

Another example of an apparatus for controlling an air-conditioning unit derives an input signal from a temperature differential and is described in Chinese Patent Application Number CN-A-200820046470 (Wensheng).

Although successful, the aforementioned systems were often expensive and complex to install and operate, sometimes requiring input from several data sources. Also because they consisted of so many remote sensors—often distributed throughout many rooms of a building—they were expensive to maintain and repair.

### SUMMARY OF THE INVENTION

According to the present invention there is provided a control system comprising: a controller that receives input signals, at least one of which is a signal from a thermostat which is in thermal contact with a mains water supply, the input signal from the thermostat detects a change in temperature when water passes in said mains water supply thereby indicating whether a building is occupied.

An advantage of the invention is that it is relatively cheap to produce, simple and quick to install and is capable of being retro-fitted to run in conjunction with existing heating, ventilation and air conditioning control (HVAC) systems so as to provide an indication of occupancy of a building by monitoring a variation in the temperature of standing water in a mains cold water riser.

Preferably the system comprises: a server; a man to machine interface capable of communication with the server to provide dynamic information; a central control unit which is capable of communication with at least the server and arranged to receive signals therefrom; and at least one room node connectable to the central control unit for providing information about conditions within a room to the central control unit, whereby, the information about room conditions is compared to planned information and/or dynamic information and adjustments made accordingly.

Preferably, the room node comprises sensors which provide information about conditions in the room.

Ideally in the present invention, knowledge of current location of a potential occupant is combined with historic knowledge of what has previously happened (most people are creatures of habit and have repeated sequences of day-to-day life). Knowledge of current location can be derived from one of several sources including: GPS and other location based sources.

In a preferred embodiment, planned information is provided by an electronically stored calendar, which optionally includes data that has been input by independent users.

The present invention uses a method of measuring when direct hot water is called for, together with usage by either a flow sensor or by extrapolating usage. For example by reducing the temperature within a tank allows the system to predict what temperature needs to be achieved within the tank to fulfil the hot water needs throughout the day. predictive process utilises inputs based on calendars, historic events (such as habitual awakening times), ambient temperature and presents and future weather compensation algorithms, so as to provide a heat sink when weather compensation is taking place as described below.

Preferably dynamic information includes one or more of changes to planned occupancy; the effect of solar heating; and the effect of weather conditions. Changes to planned occupancy are preferably established through one or more of: detecting location of a user; detecting destination of a user; and calculating estimated time of arrival (ETA) of a user.

Location of a user is preferably established internally using one or more room sensors or externally using the man to machine interface or externally by way of a GPS tracking system and/or an expected time of arrival based on historic activities.

In a preferred embodiment, wherein the system includes hot water sensors which are connectable to the central control unit for providing information about hot water conditions to the central control unit whereby, the information about hot water temperature in a supply or in a storage tank/reservoir is compared to planned information and/or dynamic information and adjustments made accordingly.

According to another aspect of the invention there is provided a method of controlling a heating, ventilation and air conditioning (HVAC) system for a building comprising the steps of: providing information relating to planned use of the building; and updating this information based on dynamic information such as user location, user destination, estimated time of arrival of a user, weather conditions, solar radiation effect, user input information and sensor information related to the building.

The system ideally uses both planned and dynamic knowledge of day-to-day usage of a building and heating facilities as well as weather affecting an individual building and number and location of personnel. Through a number of methods, the system knows, and learns, where occupants of a building are in order to plan and efficiently control the heating or cooling cycles of a buildings HVAC apparatus. That is the system provides predictive temperature control adaptation through location. This preferably includes provision of a hot water supply.

A number of elements can be utilised separately or in any combination to achieve the object of the invention. The elements include a comprehensive calendar, dynamic decision making and control of buildings and rooms therein, use of local weather conditions, remote access for dynamic updates, querying unexpected in occupancy, dynamic monitoring of occupancy.

According to a further aspect of the present invention there is provided a controller that receives input signals from at least two inputs, at least one input being from a mobile communication unit, the controller includes: a processor operative to provide at least one control signal for controlling a device in dependence upon the input signals and in accordance with control software, which operates to issue control signals based upon said input signals and location specific data received from the mobile communication unit.

Preferably the input signal includes a signal from the group of variables including: latitude and longitude of the location of where the controller is being used, season, day, time, temperature, the weather conditions humidity, amount of sunlight, state or condition of an actuator, a proximity sensor, an alarm and a remote control centre.

The controller ideally receives input signals from at least two inputs, at least one of said inputs being from a thermostat, the controller includes: a processor operative to provide at least one control signal for controlling a device in accordance with control software, whereby decisions are made whether to issue a control signal based upon said input signals, characterised in that the thermostat is in thermal contact with a mains water supply and an input signal detects a change in the temperature of water passing in said mains water supply.

A mobile communication unit has a controller that includes: a processor operative to provide at least one control signal for controlling a device in dependence upon the input signals and in accordance with control software, which operates to issue control signals based upon said input signals and location specific data received from the mobile communication unit.

A controller receives a plurality of input signals, at least one of which is received from a neural network

The invention will now be described, by way of example only, with reference to the accompanying drawings, in which:—

### BRIEF DESCRIPTION OF THE DRAWINGS

FIG. 1 is a schematic diagram of a system according to the invention;

FIG. 2 is a schematic of a central control unit according to the invention;

FIG. 3 is a schematic of a room probe according to the invention;

FIG. 4 is a flow diagram of a system process according to the invention;

FIG. 5 is a flow diagram of a process to input/update personal information via a user interface according to the invention;

FIGS. 6a and 6b are flow diagrams of a calendar according to the invention;

FIG. 7 is a flow diagram of a process to establish estimated time of occupancy according to the invention;

FIG. 8 is a flow diagram of a process to establish building occupancy according to the invention;

FIG. 9 is a flow diagram of a process to establish solar heating according to the invention;

FIG. 10 is a flow diagram of a process to establish sunrise and sunset according to the invention;

FIG. 11 is a flow diagram of a weather comparison calculation according to the invention;

FIGS. 12a and 12b are flow diagrams of a master central control unit according to the invention;

FIG. 13 shows a chart indicating occupation of a building for the previous 24 hours;

FIG. 14 is a chart indicating boiler temperature for the previous 24 hours; and

FIG. 15 is a diagrammatical overview of one embodiment of a sensor in situ on a mains riser.

### DETAILED DESCRIPTION OF THE ILLUSTRATED EMBODIMENT

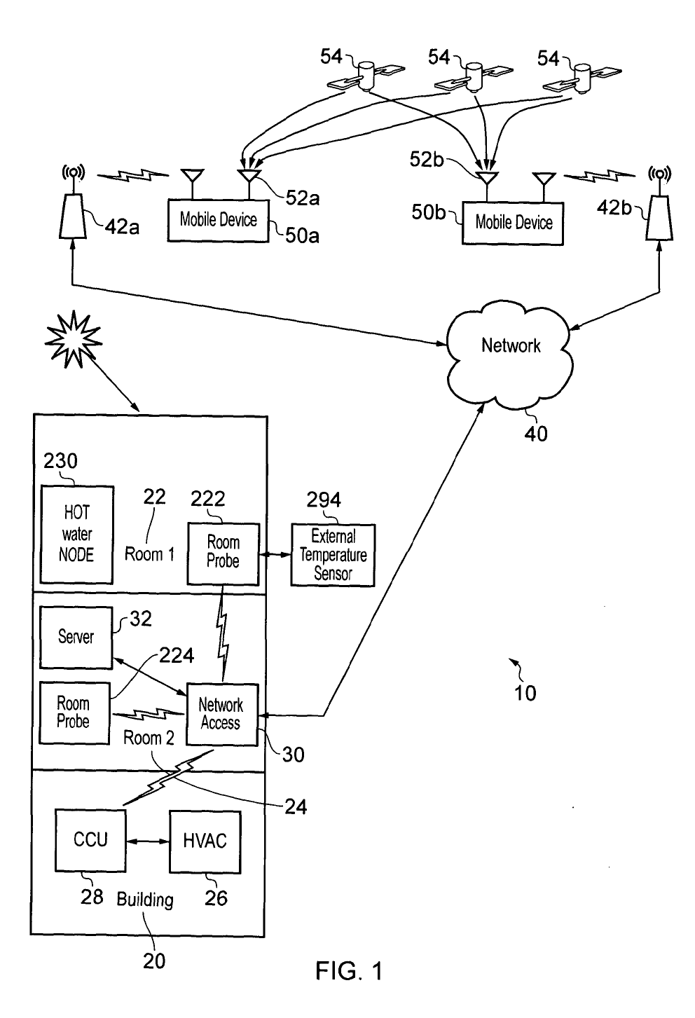

FIG. 1 is a schematic diagram of a system 10 according to the invention.

There is a building 20, which is connectable to one or more mobile devices 50a and 50b via a network 40.

In this example, the building 20 has two rooms 22, 24 each having a room probe 222, 224 respectively which is capable of monitoring a number of things such as temperature and occupancy for example. One of the room probes 222 is in communication with an external temperature sensor 294. Room one 22 additionally includes a hot water tank and the hot water node 230. The building 20 also houses a HVAC 26 which is controlled by a CCU (central control unit) 28 and a network access point 30 which, in this example is connected to a server 32 which includes a data store or database and wirelessly connected to the room probes 22, 24 and the CCU 28.

The network access 30 can access a network or internet 40 which links to one or more mobile devices 50a, 50b via any of a number of receiver/transmitter units 42a, 42b. In a preferred embodiment, the mobile devices 50a, 50b also contain a GPS or similar link 52a, 52b which can receive location information from satellites 54 which can be transmitted to the server 32 and CCU 28.

The mobile device 50a, 50b enables remote access to a HVAC control system by the householder allowing dynamic updates to be made due to the system in the event of unforeseen circumstances for example, working late or staying away tonight. This aspect is preferably securely accessed across the internet using for example smart phones and personal computers.

The server 32 monitors the current situation from data supplied by probes 222,224,230,294 and if it does not match with either normal usage or any modified instruction, the server 32 requests information from a user to confirm that the currently programmed schedule is not correct this is called user assumptions control. The system contacts the user requesting confirmation of assumption and thus permitting appropriate change to the HVAC operation calendar. For example, supposing the system detects no occupancy for say a whole day and night, then the user would receive a message (perhaps on a smart phone) asking if they are away, perhaps on holiday or business? If so when they do plan to return? Thus the HVAC can be controlled accordingly to minimise energy usage.

The server 32 can either be located within the building 20 as shown or within the internet/network cloud 40. The server 32 preferably provides three main system functions: centralised calendar; centralised decision making; and centralised communication.

As a minimum, the server 32 holds a 365-day calendar information for the HVAC system. Additionally and preferably it also holds the calendar of each of the occupants of the building. The HVAC system updates this calendar on a regular basis keeping track of when a building is in an occupied or unoccupied state.

The second function of the server 32 is to receive information from the sensors described in this document in order to provide dynamic decisions (where the calendar function is static) in order to improve the overall system performance.

The server 32 is also used to maintain ad-hoc two-way communication between the householder and the HVAC system elements located in the building 20 thereby becoming the man to machine handling agent. Communication is normally provided via a custom application on a mobile internet enabled smart phone 50a,50b such as an iPhone or an android device and can be used by the householder both within and remote to the building. This purpose-designed interface is used to receive information from the server 32 through the handling agent such as exception queries and thus allow the householder to manage the system accordingly. Through this interface the householder can also communicate new and amended calendar updates to the server. This smart phone application also can also act as a remote sensor in identifying an individual's location mainly by GPS, Wi-Fi or cell site triangulation methods and hands this information to the server for geo location processing. Alternative man to machine interfaces is provided via a desktop PC web browser interface or dedicated Windows/OS-X/Linux application interfaces.

All of the above components combined allow for a complete system that drives maximum efficiency from any heating or cooling unit thereby reducing cost and CO₂ emissions.

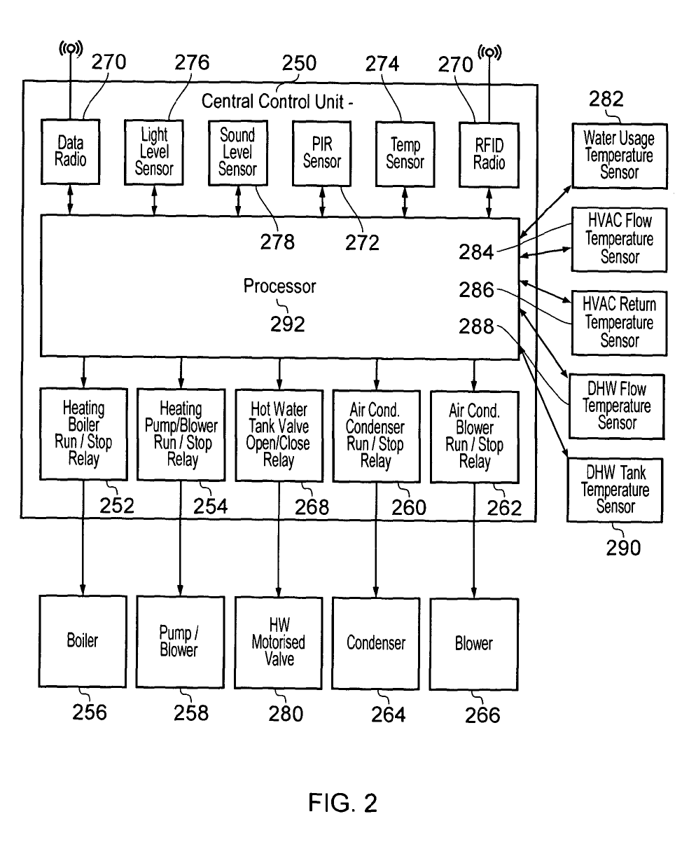

FIG. 2 is a schematic of a central control unit or CCU 250. The CCU 250 includes a processor 292 for processing data received from sensors or through external data links 270.

The CCU 250 is generally located within the building (not shown) being controlled. The primary purpose of the CCU is to coordinate and control all other HVAC system elements. In the absence of modifying instructions from the server (not shown), the CCU 250 provides the minute-by-minute decision-making and system control. If necessary due to perhaps communication link problems with the server, the CCU is capable of running the HVAC system indefinitely itself. In normal operation the CCU receives near future modifying data 270 from the server on both a periodic and dynamic basis. Using a combination of information from the server 250 and other system elements the CCU needs to decide upon the state of the building occupancy. This information allows the CCU to make decisions on turning the boiler 252, 256 and the heating pump/blower 254,258 or cooling 260,264 and cooling blower 262,266 of the building on or off. Information sources included in the decision making process are movement using a PIR sensor 272, cold water supply flow, temperature 274, light level 276 and sound 278 sensors that are either built into the CCU 250 or from other local or remote sensors described below.

In order to achieve maximum efficiency throughout the changing seasonal periods the CCU 250 preferably compensates for current and forecast weather from either a system attached outdoor temperature sensor and/or internet sourced weather forecast data for the local area.

Additional CCU 250 functionality includes predictive hot water and predictive temperature control as outlined later in this document for both condensing boilers and non-condensing boilers.

HVAC temperature and performance is assessed using an HVAC flow temperature sensor 284 and an HVAC return temperature sensor 286. This data helps in determining and improving efficiency of the system.

The Hot Water Node (HWN) 230 (see FIG. 1) is used for indirect hot water systems where the water is stored in a separate tank and is heated via a heating coil embedded within the tank, in effect a heat exchanger. From the HWN two temperature sensors are fitted, one at the bottom and one at the top of the tank to monitor the hot water temperature and can be configured to report exception high low to the CCU based around periodic and seasonal hot water needs. Again this node is fitted with a PIR and integral temperature sensor in order to monitor movement and ambient temperature within that location of the building.

For direct hot water (DHW) systems, a DHW flow temperature sensor 288 and a DHW tank temperature sensor 290 are provided. These can provide information relating to hot water usage so data can be utilised to predict hot water requirement and occupancy of the building as well as establishing the actual temperature of the water and whether that is within parameters.

Information regarding the temperature 288,290 and use 282 of hot water can be used to control the temperature of the water via the hot water valve 268,280.

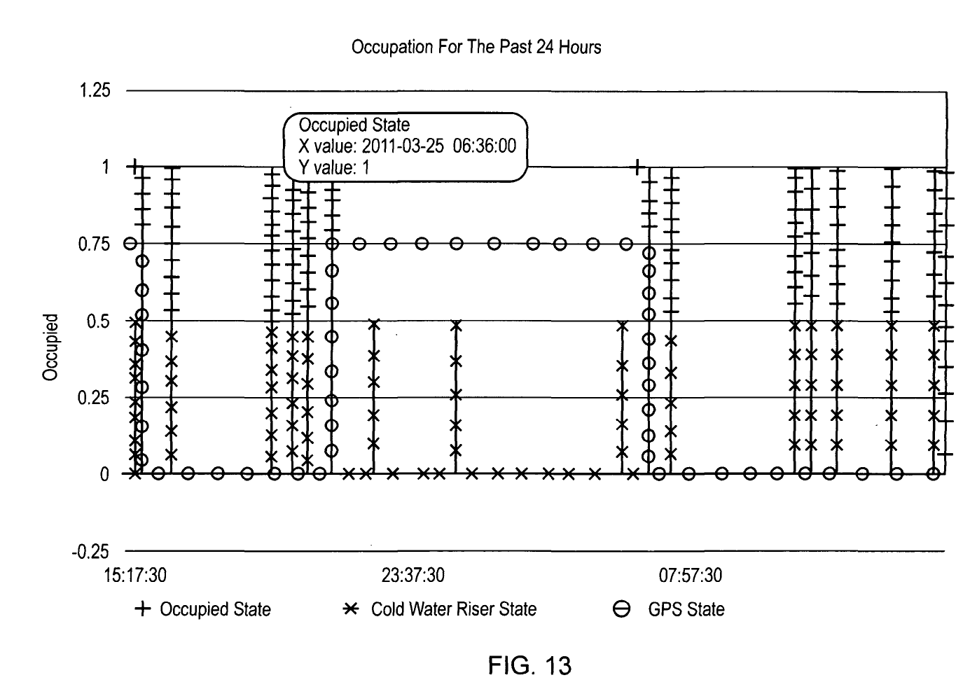

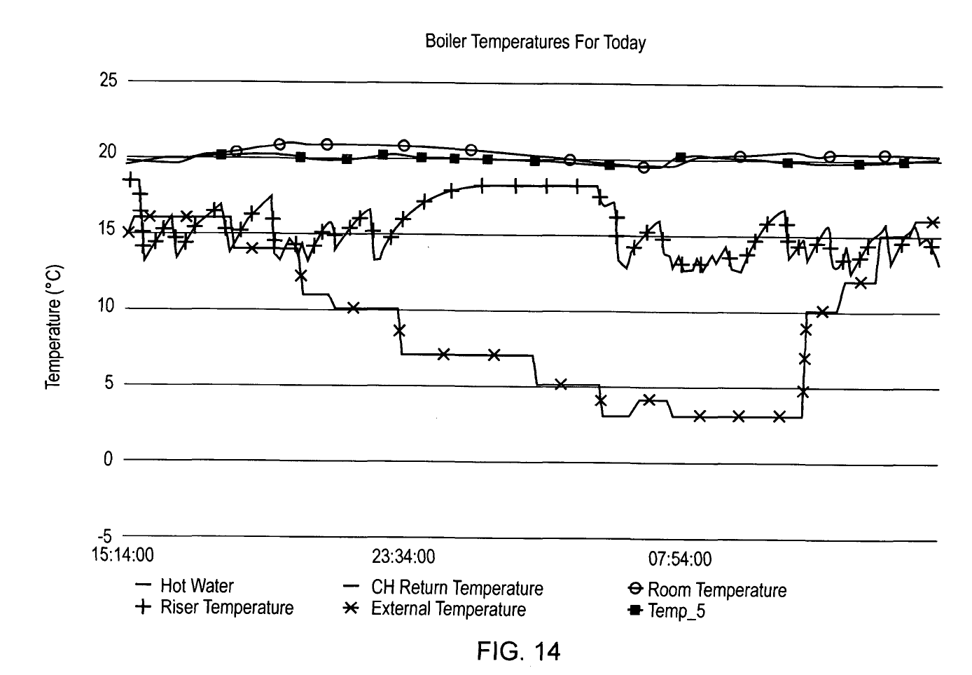

In addition to monitoring temperature all nodes are fitted with a PIR and light sensor to look for movement activity and the turning on and off of household lights. The light sensor is also used to help identify solar radiation that may have a thermal heating effect on the building. If occupancy is expected, but not detected within a pre-defined period, the server can request confirmation from the householder via the man machine interface whether or not to set the system to an un-occupied state. This forms part of the dynamic decision making of the system and may be triggered by events such as flushing a lavatory (WC), running a bath or turning on a tap (faucet) in order to fill a kettle so as to boil water to make a hot drink. All these events giver rise to a sudden decrease in input temperature, as depicted by spikes in the graph (FIG. 13), of water entering a building from a cold riser. This input signal is combined with other signals and used to control the heating system by indicating occupancy of a building. The resulting fluctuations of temperature of a boiler are show in FIG. 14.

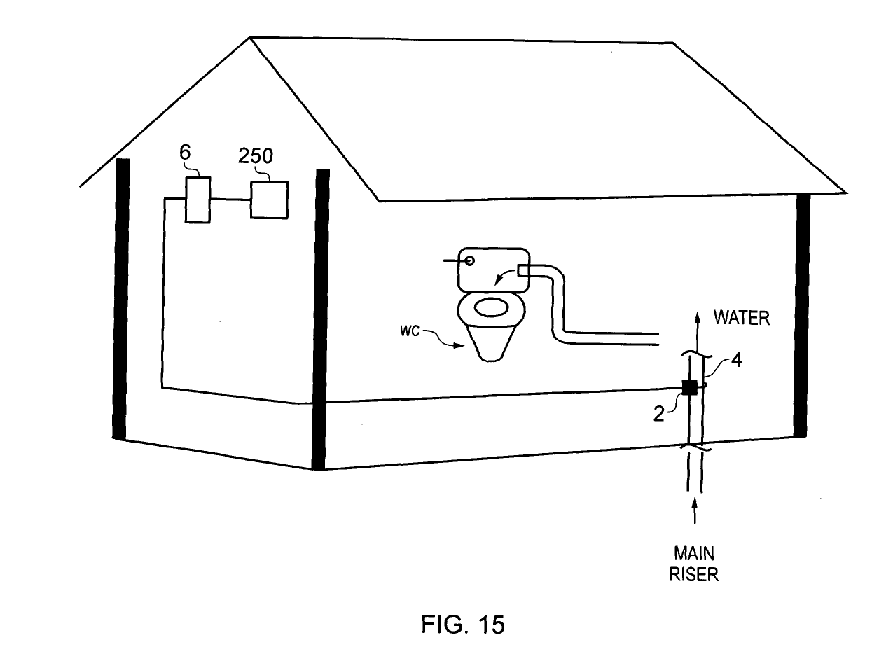

FIG. 15 shows a diagrammatical overview of one embodiment of a sensor 2, which is a thermostat or temperature measuring device, in situ on a mains riser 4 and providing a temperature reading to a control unit 6. The mains riser may be connected to water appliances in the building such as a sink 8, toilet, hot water device, and the like. The control unit 6 may be part of the central control unit 250. The control unit 6 may communicate with the central control unit 250. The control unit 6 may be battery powered or mains powered. If it is battery powered ideally there is provided an alert (audible alarm or some other means by which a user is informed that it is necessary to change the battery. This could be done by a radio frequency alert such as an ‘SMS’ message to the users mobile telephone. Optionally a back-up battery is provided so that the sensor is always providing an update to a boiler control as described below.

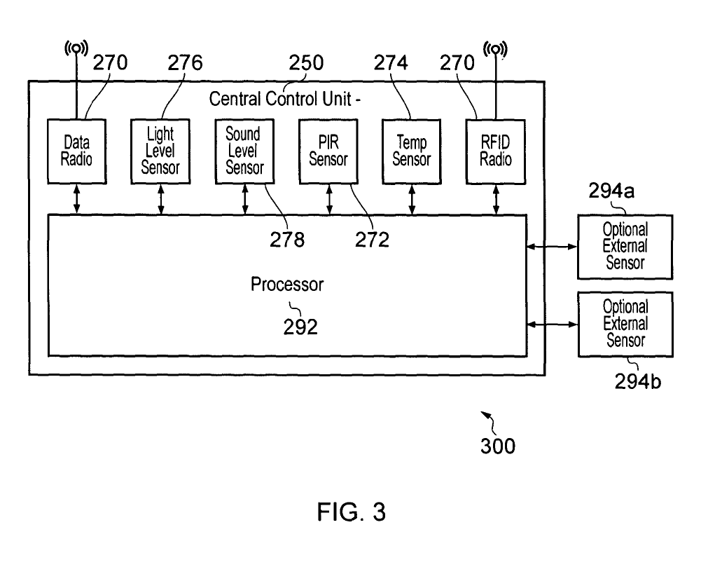

FIG. 3 is a schematic of a room node 300. The same references numerals as were used in respect of FIG. 2 denotes common features. Room node 300 monitors temperature within the room and has high and low threshold parameters stored in the processor 292, which it checks on a periodic basis to ensure that the ambient temperature is within the set range as defined by the CCU 250. When the temperature goes under range an exception message is sent to the CCU in order to provide a secondary state change. When the temperature goes over range an exception message is sent changing the secondary state back.

Optionally, in addition to monitoring temperature 274 all nodes are fitted with a PIR 272 and light 276 sensors to determine movement activity and the turning on and off of household lights. A sound sensor 278 is preferably provided for times when an occupant may be stationary. The light sensor 276 is also used to help identify solar radiation that may have a thermal heating effect on the building. These are techniques for determining occupancy of a building.

If occupancy is expected, but not detected within a pre-defined period, the server can request confirmation from a householder via a man machine interface whether or not to set the system to an un-occupied state. This forms part of the dynamic decision making steps of the system.

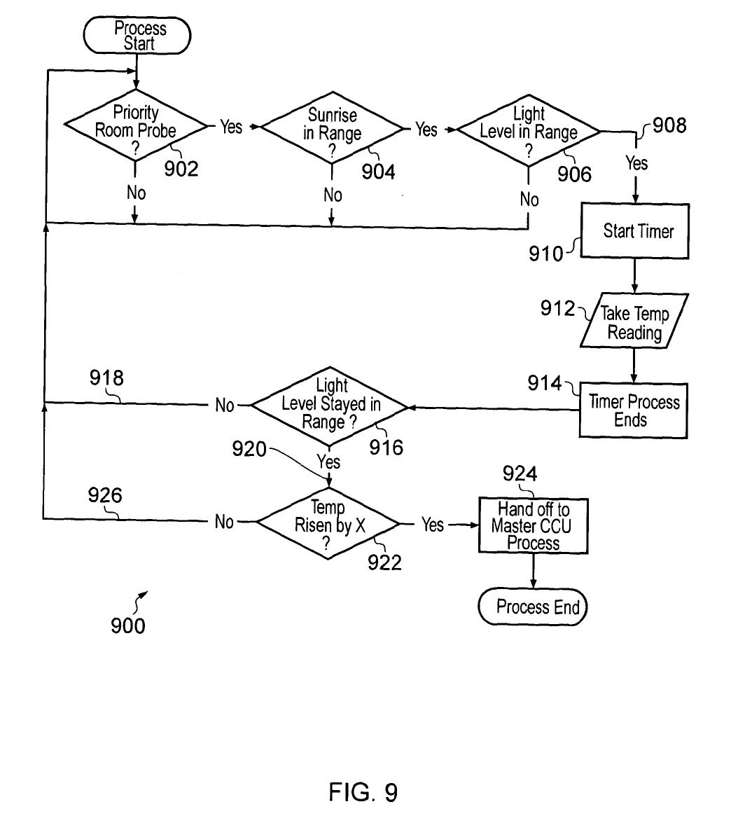

One or more external sensors 294a, 294b are preferably provided to supplement any information from the light sensor 276 regarding the external conditions of the building. This is explained further with respect to FIGS. 9 to 11.

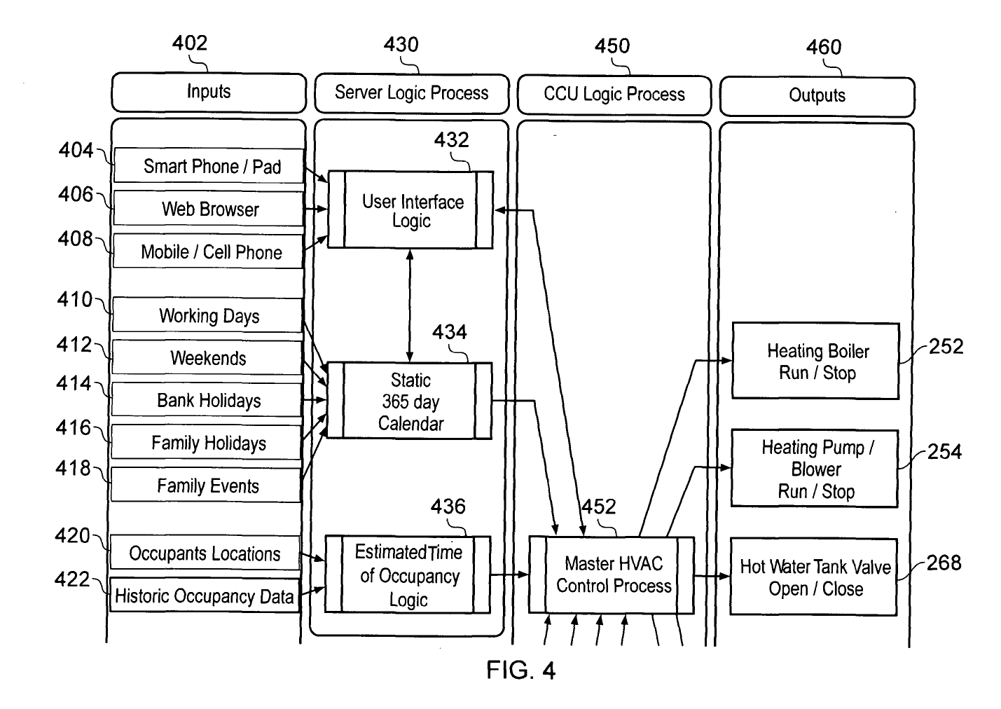

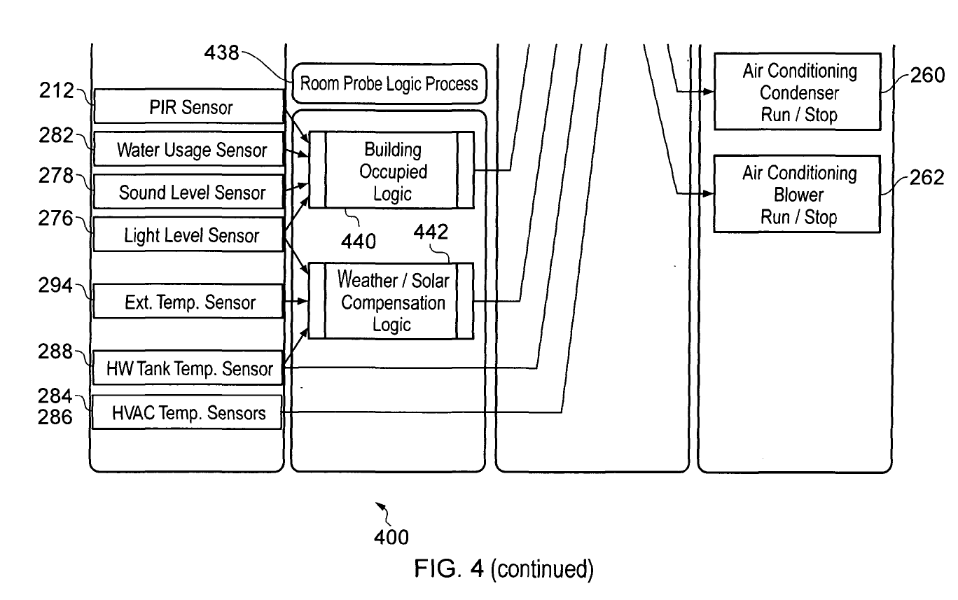

FIG. 4 is a flow diagram of a system process 400 according to the invention having four main sections inputs 402, server logic process 430, CCU logic process 450 and outputs 460. Again, features which have been previously described are denoted by the previously used reference numerals.

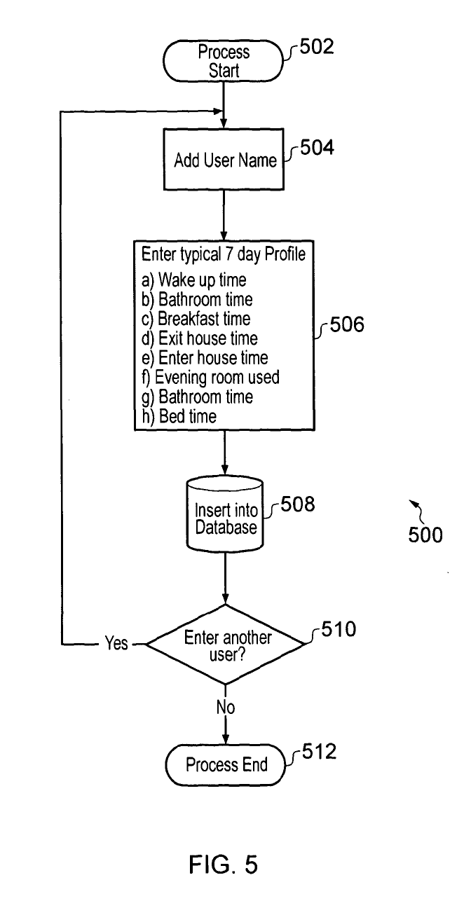

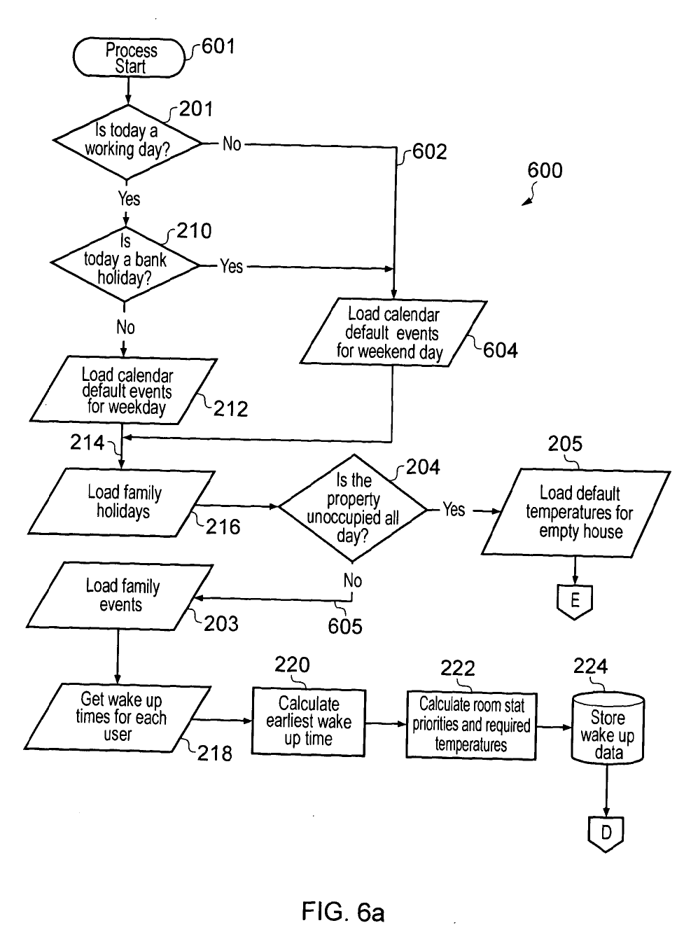

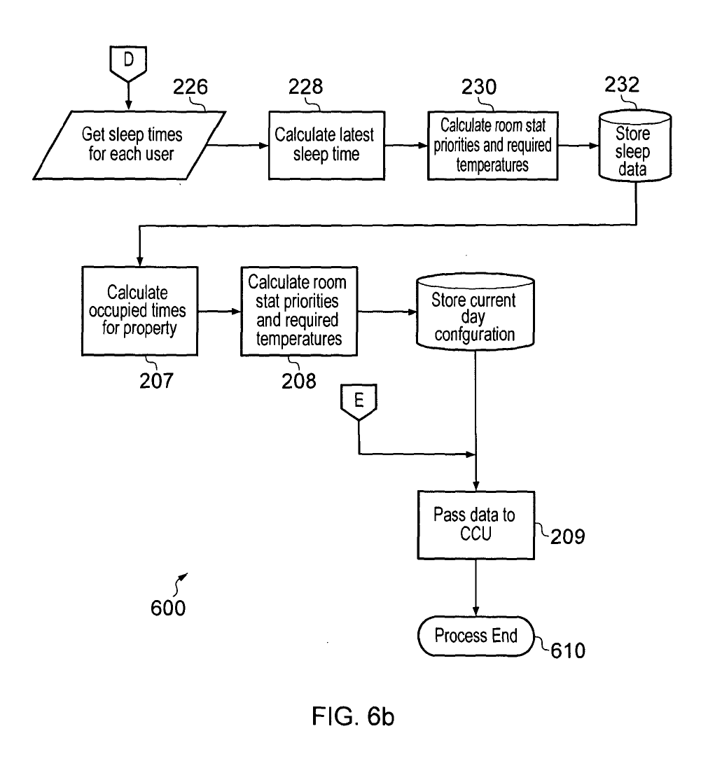

The interface is normally provided via a custom application on a mobile internet enabled smart phone 404 such as an i-Phone (Trade Mark) or an Android (Trade Mark) device and can be used by the householder both within and remote to the building. A normal mobile or cell phone 408, or a web browser 406 could also be utilised. This purpose-designed interface is used to exchange information from the server through user interface logic 432 to the handling agent such as exception queries and thus allow the householder to manage the system accordingly. Through this interface the householder can also communicate new and amended calendar updates to the server. This is described in more detail with respect to FIGS. 5, 6a and 6b.

Typical calendar inputs include working days 410, weekends 412, bank holidays 414, family holidays 416 and family events 418 which are input into the static calendar 434. The static calendar 434 can interface with the user interface logic 432 to receive amendments to the calendar.

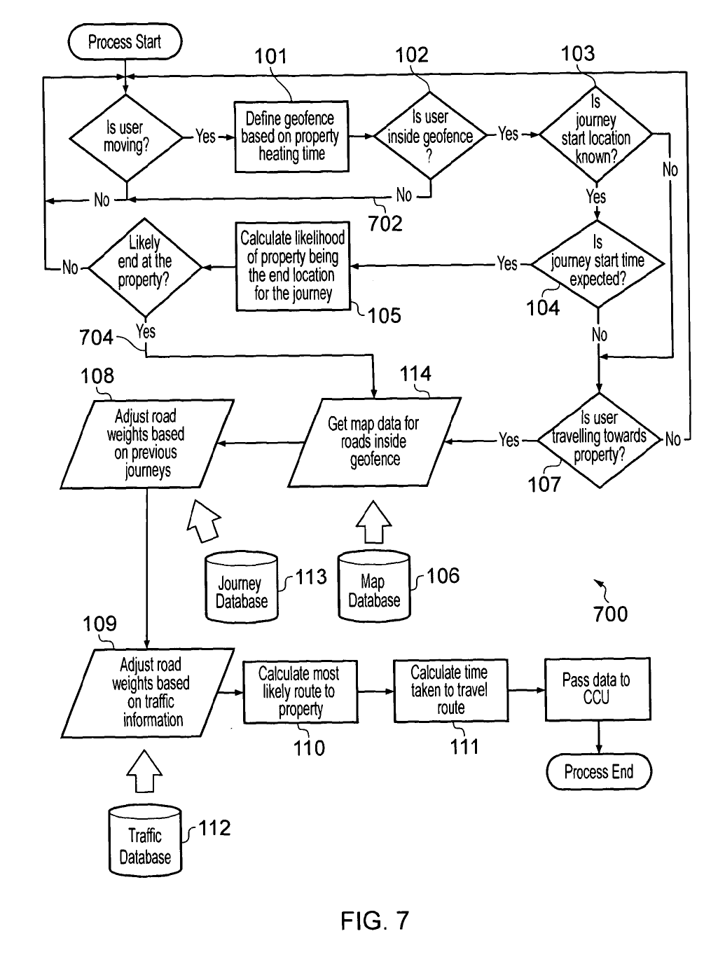

Occupancy information can also be inputted to the system via actual occupant/user location 420 as well as utilising historical occupancy data 422. This information is fed to the estimated time of occupancy logic 436 to enable the HVAC to activate in response to an approaching user so, for example the building is heated only when required to meet the temperature settings for arrival of an occupant/user. This is described in more detail with respect to FIG. 7.

Any sensor information 272, 282, 278, 276 from within the room nodes 438 of the building is input to the building occupied logic 440 to establish if and where in a building there is occupation enabling adjustments to be made accordingly. External sensor information (including external information obtained from internal sensors) 294,288,276 is fed to the weather/solar compensation logic 442 enabling external factors to be taken into consideration. This is described in more detail with respect to FIGS. 9, 10 and 11.

All this information from the user interface logic 432, static calendar 434, estimated time of occupancy logic 436, room probe logic process 438, building occupied logic 440, weather/solar compensation logic 442 and hot water sensor 288, 284, 286 data is relayed to the master HVAC control process 452 held within the CCU logic process 450. This process 452 uses the data and information to determine if the heating boiler should be run or stopped 252, if the heating pump/blower should run or stop 254, whether hot water tank valve should be open or shut 268, if the air conditioning condenser should run or stop 260 and if the air conditioning blower should run or stop 262. What runs or stops is based on what the situation is now, what it is predicted to be and what the set parameters e.g. temperatures are so the system runs efficiently to produce the desired user requirement.

FIG. 5 is a flow diagram of a process 500 to input/update personal information via a user interface. The user starts the process 502 by accessing a server or CCU held database and using a menu function selects in this example a new user 504. Of course, if an existing user name were selected changes to that profile could be made. A number of prompts 506 are made to establish the routine of the user. This example is for a domestic building so wake up time, bathroom time, breakfast time, exit house time, enter house time, evening room used, bathroom time and bed time are requested from the user. For a business situation, work room start and finish times (including lunch arrangements) would be required.

The inputted information 506 is then sent to the database 508 and an option to enter the details for another user is offered 510. If the option to input data for another user is taken, the process starts again at the enter user name step 504 otherwise, the process ends 512.

FIGS. 6a and 6b are flow diagrams of a calendar 600 according to the invention. The system utilises a more comprehensive 365-day calendar than conventional systems. This calendar is inputted with knowledge of planned building occupancy over the year so for example, use over the Christmas period or other holiday times and non-usage for a period due to family holidays is given to the system. This is in addition to the more regular day-to-day usage including knowledge of normal wake-up time, normal go to work time, normal come home time, normal go to bed time amongst other things as detailed with respect to FIG. 5.

As a minimum, the server holds 365-day calendar information for the HVAC system on a database. Additionally and preferably it also holds the calendar of each of the occupants of the building. The HVAC system updates this calendar on a regular basis keeping track of when a building is in an occupied or un-occupied state. It should be noted that the server's calendar function is not exclusive for this system but can be used in order to manage individuals' lifestyles in the way that an ordinary calendar is used today. This part of the server handles the “When” part of the solution.

A Gregorian calendar is used that is initially populated through a set up wizard when commissioning the system, which creates a baseline calendar for each of the buildings occupants, see FIG. 5 for general daily routine and this daily routine is supplemented, using the set up wizard with the following information: typical normal time leaving the building Monday to Friday; typical normal time arriving at the building Monday to Friday; regular events at weekends; and planned holidays throughout the 365 period and beyond. This information is then used to calculate the baseline occupied/un-occupied states for the CCU to plan the boiler on/off state.

When the system checks on the routine for the coming day, perhaps at midnight or noon if the occupants are night shift workers, the process starts 601. The system firstly checks if it is a working day 201 and if so, whether it is a bank holiday 210, if not the process turns to default weekday events 212. If it is not a working day, the system turns 602 to the weekend default for that weekend 604.

Next 214 the system loads family holidays from the database and any mobile or locally inputted updates 216. A query of whether the building is due to be unoccupied all day 204 is asked. If the answer is yes then the default temperatures for an empty house 205 is loaded and this data is passed to the CCU for storage 209 followed by the process ending 610. If the answer is no 605 then family events 203 are loaded from the database. The process obtains wake up times for each user 218 and uses this information to calculate the earliest wake up time 220 followed by a calculation for room stat priorities and required temperatures 222. This wake up data is stored 224. Next sleep times for each user are obtained 226 and the latest sleep time calculated 228 followed by a calculation for room stat priorities and required temperatures 230. The sleep data is stored 232. Further family event information is used to calculate occupied time for the property between wake up and bedtime 207 followed by a calculation for room stat priorities and required temperatures 208. The day configuration is stored 234 and passed to the CCU 209 followed by the process ending.

Any changes to the stored configuration are either input by a user or dynamically realised by the system using sensors and locating devices and result in the configuration being changed either by going through the process or a part of it or using an override facility in the CCU.

FIG. 7 is a flow diagram of a process to establish estimated time of occupancy 700. In this embodiment, a smart phone also acts as a remote sensor in identifying an individual's location mainly by GPS, Wi-Fi or cell site triangulation methods and hands this information to the server for geo location processing providing dynamic updates to the server on the fly based around the known whereabouts of the household and there travel status.

In simple terms with knowledge of current and expected internal and external temperatures the heating/cooling can be turned on just in time to reach the householders chosen temperature at the required point in time. This control is dynamic, so that the HVAC switches on earlier on days with a bigger internal to external temperature differential. An example from real data is provided below.

To reduce the amount of time the boiler is running when heating the property, the boiler control has access to the location information of people that live in the property. This not only allows us to detect when the property is unoccupied but also allows us to predict when the property is likely to be occupied again.

Using location information it is easy to detect when a person is at the property. However, there needs to be a way for the boiler control to start heating the property before a person arrives home. This gives the property time to come up to the required temperature before the person arrives. To do this, the boiler control needs to detect the location of the person, decide if the person is travelling to the property, then calculate the estimated time of arrival (ETA). Once the ETA of arrival has been calculated, the boiler control can decide when the turn on the boiler and start heating the property.

Location is pushed to the boiler control from supported tracking applications, for example Cuspus iPhone. The last known location is used when calculating the ETA. The boiler control server logs each positional update, and uses the historical data to improve the ETA calculation.

The person being tracked can move at any time, but may not have the property as their immediate destination. There are a number of ways to detect that the person is travelling to the property.

The boiler control knows the maximum amount of time it takes to heat the property to the required temperature. Using this information, the boiler control can define an area (geofence) 101 outside of which it does not need to track the person. This geofence 101 can expand and contract depending on the amount of time required to heat the property. The size of the geofence 101 is determined by the distance it is possible to travel in the time taken to heat the property. This differs between properties based on the road types in the surrounding area. Until the person enters the geofence 102, the boiler control assumes that the person is not travelling to the property 702.

The boiler control has access to historical positional data. This includes previous journeys that the person has made. The boiler control can then make an assumption based on the start location 103 and time of the current journey 104. For example, if 90% of journeys that start at the persons' place of work at 5 pm, end at the property, the boiler control can assume that when the person leaves work around 5 pm, there is a good chance 105 they are travelling to the property 704.

Once the boiler control has decided that the person is travelling to the property 704, 107 it needs to calculate an ETA. The boiler control can then use this ETA to decide when to start heating the property. To determine the ETA the boiler control must calculate the time a person takes to travel back to the property 111. This requires the boiler control to determine the most likely route back to the property 110. Initially, the boiler control assumes that the shortest route (in time) will be the one taken.

To calculate the route 110 and the duration 111 of the journey along the route, the boiler control accesses a database of map data 106. This data contains information for each road segment and routing information to show how the roads connect together. Once we have this information, the shortest route can be obtained by using a method based on Dijkstra's algorithm. The cost for each edge (road) is calculated from the length of the road and the speed limit of the road. Using historical data 113, the cost for the edges is adjusted 108 based on actual travel time along the road segment and time of day. This allows the system to take into account daily variances such as rush hour traffic 109. The cost of each edge is also be adjusted when external data sources 112 inform the system of special events on the road segment, such as roadworks 109. Edge costs are adjusted favourably if historical data shows that the person often travels along that road at that specific time. This allows the boiler control to make a more informed decision on which route the person is likely to take.

As Dijkstra's algorithm can be computationally expensive, the boiler control decreases the amount of data that needs to be processed by only including roads 114 that fall within the so-called geofence defined when determining the destination. The boiler control also performs a bi-directional search, where the search is performed simultaneously from the start location and the destination. The shortest route is then found when a node (road junction) has been visited by both searches.

Once the shortest route has been calculated, the ETA can be found by adding the costs (in time) of all roads in the route. The boiler control re-calculates the ETA on a periodic basis, to ensure the person is still travelling to the property. Once the ETA is known, the boiler control can determine when it needs to turn the heating on to make sure the temperature is at the correct level when the person arrives.

If an occupant leaves the building unexpectedly, remote dynamic override can be used to account for this. Remote dynamic override can be triggered manually by the user through the man machine interface; alternatively and uniquely it can be triggered by utilising location based information from various sources such as GPS, cell site triangulation Wi-Fi node location or RFID technology. The trigger happens when the individual leaves a defined zone, this could be a radius set around the location (a geofence) in the case of RFID this triggers an event when the individual leaves the building.

When the trigger happens the man to machine interface starts a background application that sends periodic location updates to the server using its built in GPS or cell site triangulation to the server. The server has a built in dynamic geo-fence that changes based around the outside temperature at the property, this means when the temperature is low the geo-fence increase and when the temperature is higher the radius decreases thereby dynamically triggering and managing most efficiently the heating/cooling start up time in line with the predictive and adaptive temperature control as defined above.

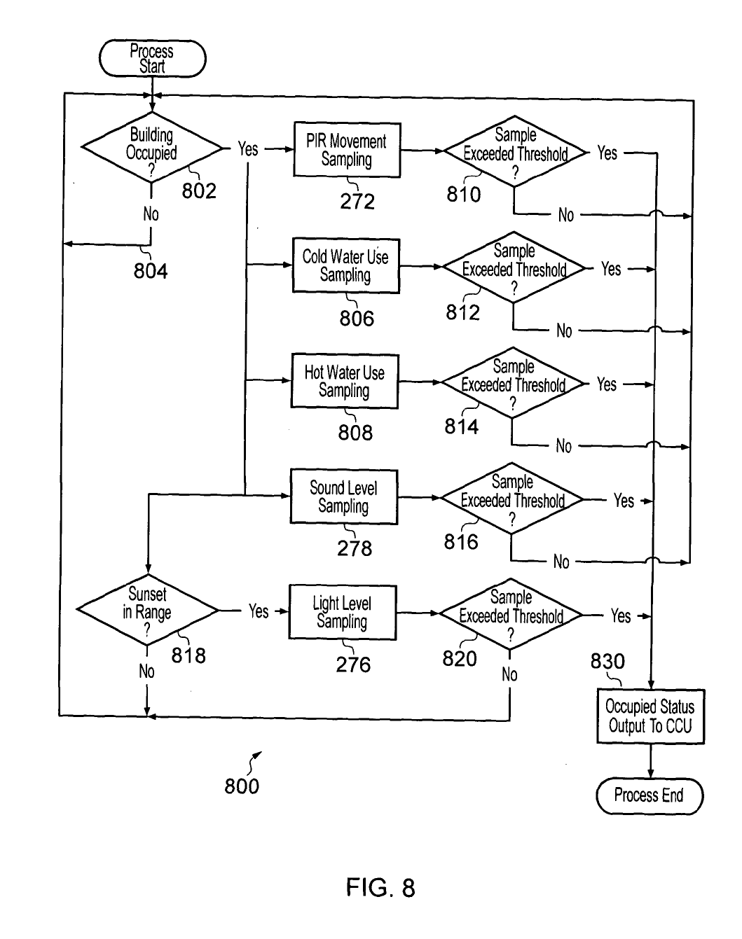

FIG. 8 is a flow diagram of a process to establish building occupancy 800. Dynamic decision-making and control of the buildings HVAC apparatus is enabled by taking into account knowledge of the location of the building users. This is not just limited to one individual but takes into consideration the actual or predicted location of either family members or maybe the employees of a business.

Dynamic occupancy methods are utilised to make decisions as to whether the building is in an occupied 802 or unoccupied 804 state. Sensors such as passive infra red 272 for the hours of darkness; light sensing 276 for both room use indicated by lighting being used and daylight; and monitoring the cold 806 and or hot water 808 usage either through a flow sensor or change in temperature into the house can confirm occupancy. When one of more of the PIR movement sampling 272, sound sampling 278 and cold and/or hot water use sampling 804, exceed a threshold 810,812,814,816 respectively a signal stating that the building is considered occupied is output to the CCU 830. In addition, if the system knows when sunset is, this data 818 can be used with light level sampling 276 to determine if lights are on in the building. Thus if the time is after sunset and the light level exceeds a threshold 820 then occupied status is output to the CCU 830.

Traditional HVAC control systems work on the simple basis of a programmer that sets the on time for the HVAC to start up normally on a seven day rotational cycle to provide heat or cooling to the property. This works in conjunction with the room temperature thermostat in a logic configuration so if both devices are demanding heat or cooling then the HVAC runs.

The issue arises that by default the user configures the system for the worst case scenario whereby if the outside temperature is cold for heating or hot for cooling the HVAC runs up with enough time to bring the property up or down to temperature before day-to-day occupancy occurs. The converse is also true in the fact that the boiler continues to run up to the point that the day-to-day occupancy ceases.

This method is extremely inefficient. With the knowledge of outside temperature and the ability of the system to calculate the buildings basic thermal efficiency (through calculating heat loss or heat gain during un-occupied periods) a much more efficient predictive control system can be created which is described with reference to the following Figures.

FIG. 9 is a flow diagram of a process to establish any effect of solar heating 900. It has been known and understood for many years how solar radiation effects the heating and fabric of a building. Firstly, as there is more than one room probe, and the room probes each talk to the CCU at intervals, the priority room probe must be selected 902 i.e. the one in communication so the data can be passed to the CCU and stored. Next the system establishes is sunrise is in range 904, if it is not after sunrise the process returns to the start and cycles through this part of the process until it is after sunrise. Next it is established if a light level range is met 906, again if not the process cycles until this criteria is also met. Once the criteria are met 908, a timer is started 910 and a temperature reading taken 912. The timer process ends 914 and it is checked whether the light level stayed within the range 916 if not, the process returns to the start 918. If the light requirement is met 920, it is established if a temperature rise occurred 922 is ‘YES’ the data is handed to the CCU process for storage 924 and later use to update the solar prediction process. If no rise is recorded, the process returns to the start 926 and the process is repeated.

A unique element of this invention is the ability to monitor solar light through a light sensor and predict the temperature rise over time from historical data captured in previous days. This equation assumes that the solar source will be constant for a period x and create a temperature rise of Y. When the predictive algorithm anticipates temperature Y rising above a certain threshold the HVAC either shuts down or start up depending on whether the building needs to be heated or cooled. This is an iterative process that monitors over period Z to take into consideration cloud cover.

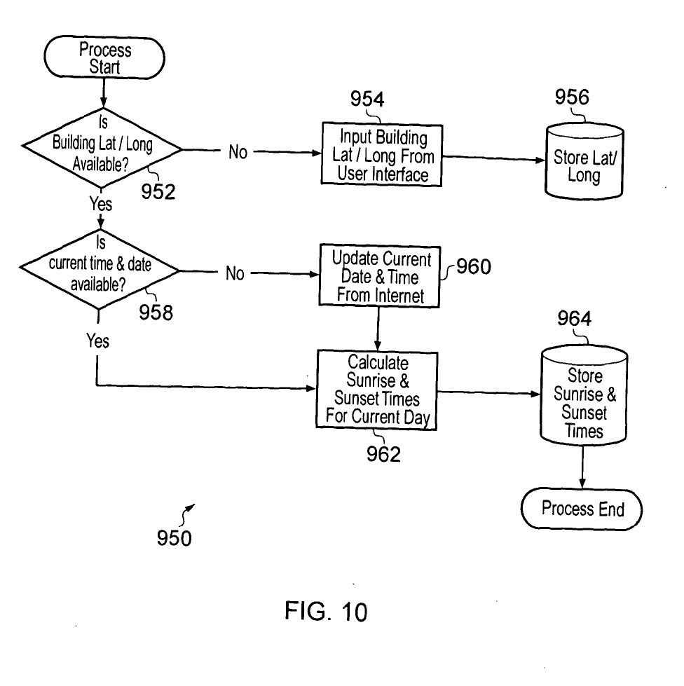

FIG. 10 is a flow diagram of a process to establish sunrise and sunset 950. Firstly, it is established whether building latitude and longitude information is available 952, if not this data is requested/input via the user interface or using an internet source 954 and stored 956. Next it is established whether current date and time information is available 958, if not these are updated from the internet 960. From this information, sunrise and sunset times are calculated for the current day 962 and are stored 964.

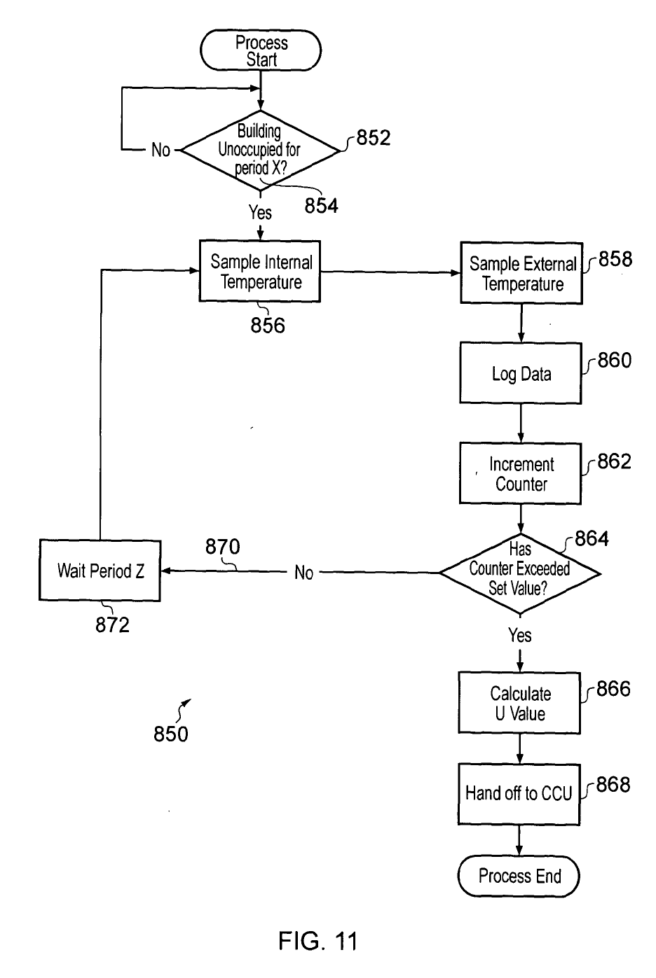

FIG. 11 is a flow diagram of a dynamic weather compensation calculation 850. First it is established whether the building is occupied 852, if it is then the process returns to the start until the building is unoccupied for a certain time period 854. The internal temperature is sampled 856 and the external temperature is sampled 858 and the data logged 860. An increment counter is set forward one count 862. After a certain number of increment counts have occurred 864, the U value is calculated 866 and handed off to the CCU 868. If the required increment has not occurred 870, the process waits for a time period Z 872 until sampling the internal temperature 856 again.

Weather compensation works by ensuring that the boiler stays in a condensing state (or on non condensing boilers reduces the temperature and thereby the load) ensuring that the efficiency of the boiler from fuel burnt is maximised. The drop off of efficiency starts when the boiler return temperature rises above 55 degrees centigrade and the efficiency decreases for every degree that rises above this temperature. Weather compensation ensures the boiler flow temperature does not rise unnecessarily by monitoring the return into the boiler.

By monitoring the outside temperature the weather compensation can either reduce the boiler flow temperature by opening the hot water flow and diverting some heat to the hot water tank. This acts as a reservoir for the room heating whereby the indirect coil acts as a reverse heat exchanger back into the room heating loop or alternatively reduce the load on the boiler by overriding the built in thermostat and firing the boiler only when the temperature drops.

Dynamic use of local outdoor temperature and forecast weather conditions which enables automatic adjustment of internal temperature to allow for human perception of feeling warm or cold; based upon factors such as whether it is a clear sunny day and better direct control of the boiler to ensure that it operates in energy efficient “condensing-mode” for as much time as possible.

Efficiency can further be improved from standard systems by dynamically monitoring the buildings heat loss. This can take place overnight when the boiler is not firing, by comparing the external temperature against the internal temperature over a period of time it is possible to calculate the value of heat loss dynamically and thereby allow the compensation for weather to be adjusted according to these losses. Practically this means that the higher the heat loss of the building the higher the temperature from the boiler needs to be relative to the outside temperature and the converse is true for efficient buildings where the flow temperature can be of a lower temperature to inefficient buildings.

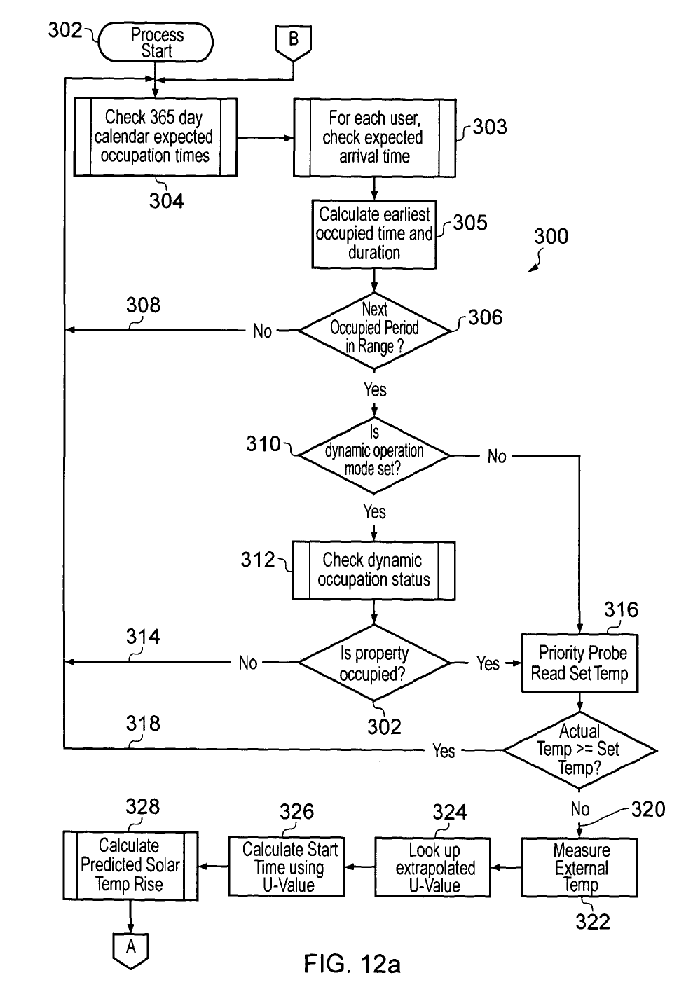

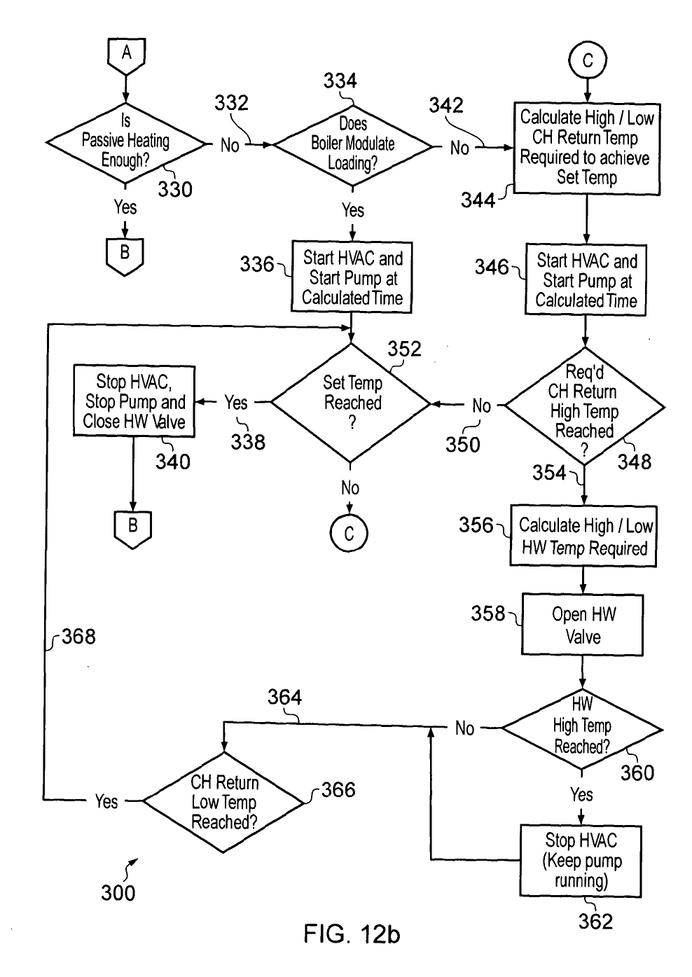

FIGS. 12a and 12b are flow diagrams of the workings of a master central control unit 300 according to the invention. At the start of the process 302 a check is made on the calendar expected occupation times 304, perhaps as described in respect of FIGS. 4, 5, 6a and 6b. Next for each user, the expected arrival time is checked 303, as outlined with respect to FIG. 7 and an earliest occupied time and duration calculation is made 305. Then, an assessment is made of whether the next occupied period is in range 306 i.e. should the HVAC respond to a potential user arrival. If not 308 then the process cycles back to the beginning. If the answer is ‘YES’ then a check is made as to whether dynamic operation mode is set 310. The system uses the multi user calendar as its point of reference to decide if the building is occupied or un-occupied. In reality it is quite likely that lifestyle events indicate that the calendar is not updated for real life situations, such as for example sickness or unscheduled appointments. The system can therefore be set to either part or full dynamic local override which makes use of the built in PIR and light sensor activity on the various nodes as well as detecting a step change in mains water, when for example someone flushes lavatory or fills a kettle. The PIR checks for continued activity even if the CCU has been set to un-occupied by the server and make the following state change to the system.

If dynamic operation mode is set then dynamic occupation status is checked 312 and if the building is not occupied then the process cycles back 314 to the start. Thus, if the system is in part dynamic local override it sends a message to the man machine interface requesting overriding of the system, if the man machine responds back with a positive yes then the system overrides to occupied state until movement activity defined by x period as set by the user man to machine interface ceases at which point the system reverts to un-occupied. If the system is set in full dynamic local control it automatically sets the system as occupied without requesting permission via the man to machine interface. Once period x has passed the status indicator reverts to building in un-occupied state.

If either the property is occupied 302 or it was previously established at stage 310 that dynamic operation mode was not set then the process moves to read the set temperature of the priority probe 316. If the set temperature is greater than or equal to the set temperature 318, the process cycles back to the start as there is no requirement to heat the building.

If the temperature is less than the set temperature 320, the external temperature is read 322 and an extrapolated U value looked up 324 (perhaps from a table held locally or accessed via the Internet). The U value is used to calculate start time 326 for any required heating.

Next, a prediction of any solar heating is made 328 and a query is asked of whether passive heating from solar radiation is enough 330 to raise the building temperature by the required amount. If the answer is yes then the process cycles back to the start B as no extra heating is necessary.

If extra heating is required 332 the process queries whether the boiler modulates heating 334. If yes, then the HVAC and pump are started at the calculated time 336, and once the set temperature is reached 338 the HVAC and pump are stopped and the hot water valve closed 340. The process then returns to the start B as the temperature is now at the required value.

If the set temperature is not reached C or the boiler does not modulate loading 342 then the process calculates high/low central heating return temperature required to achieve the set temperature 344. The HVAC and pump are started at the calculated time 346 and then a query is made as to whether the required central heating return high temperature has been reached 348. If not 350 it is checked to see whether the set temperature has been reached 352 if yes 338 then the HVAC and pump are stopped and the hot water valve closed 340 and the process returns to the start B. If the set temperature has not been reached then the process returns back C to calculating the high/low central heating return temperature required to achieve the set temperature 344.

When the required central heating return high temperature is reached 354 a calculation is made to establish the high/low hot water temperature required 356, the hot water valve is opened 358. A query is asked whether the hot water high temperature has been reached 360 if yes, the HVAC is stopped but the pump kept running 362. If no 364, a query is asked whether the central heating return low temperature has been reached 366 and if it has 368 the query of has the set temperature been reached is asked 352, if not the process cycles back to C and if yes 338 then the HVAC and pump are stopped and the hot water valve closed 340 and the process returns to the start B.

The use of the acronym HVAC (Heating, Ventilation and Air Conditioning) in this document encompasses Central Heating Boilers, Hot Water Boilers and Air Conditioning, of various fuel types (for example gas and oil) and distribution methods (for example radiators, air ducts and under floor heating).

A reference to “households” in this document includes both domestic and business premises.

It is to be appreciated that these Figures are for illustration purposes only and other configurations are possible. For example, the controller may be included in a system other than a heating control system. An example of such an alternative system might be for example, an oven or cooker, configured to switch itself on for a predetermined time at an instant when the mobile telephone of a user is within a specific cell or at a given location, thereby pre-empting the arrival home of the user. Alternatively a domestic washing machine or lighting system or sound system may be adapted to be energised so as to welcome the user on their arrival to their dwelling.

In another embodiment the controller receives input signals from at least two inputs. At least one of the inputs is a thermostat and the controller includes: a processor operative to provide at least one control signal for controlling a device in accordance with control software, whereby decisions are made whether to issue a control signal based upon said input signals, characterised in that the thermostat is in thermal contact with a mains water supply and an input signal detects a change in the temperature of water passing in said mains water supply. Therefore in use when someone turns on a tap, flushes a water closet (WC) or switches on some other domestic appliance that consumes water from the cold water mains supply. Typically such a cold water surge on a mains riser results in a drop in water temperature as standing water in the house is usually warmer than that standing in an underground pipe and this indicates occupancy in much the same way as the aforementioned sensors provide a signal but at a fraction of the capital cost and installation cost.

It is appreciated that in larger buildings, where several risers are provided, sensors are required for each riser and a system of combining signals ensures that overall building occupancy can be supervised and monitored.

The invention has been described by way of several embodiments, with modifications and alternatives, but having read and understood this description further embodiments and modifications will be apparent to those skilled in the art. All such embodiments and modifications are intended to fall within the scope of the present invention as defined in the accompanying claims.

1. A control system comprises: a controller that receives input signals, at least one of which is a signal from a thermostat which is in thermal contact with a mains water supply, the input signal from the thermostat detects a change in temperature when water passes in said mains water supply thereby indicating whether a building is occupied.

2. The control system according to claim 1 wherein the control system is adapted for use with a heating, ventilation and air conditioning (HVAC) system wherein a processor is operative to provide at least one control signal for controlling a device in accordance with control software, whereby decisions are made whether to issue a control signal based upon whether the building is occupied.

3. The control system according to claim 2 wherein the a controller receives at least two inputs, at least one input being from a mobile communication unit, the controller includes: a processor operative to provide at least one control signal for controlling a device in dependence upon the, or each, input signals and in accordance with control software, which operates to issue control signals based upon said input signals and location specific data received from the mobile communication unit.

4. The control system according to claim 2 adapted to receive input data from the group comprising: latitude and longitude of the location of where the controller is being used, season, day, time, temperature, ambient weather conditions, humidity, amount of sunlight, state or condition of an actuator, a proximity sensor, an alarm and a remote control centre.

5. The control system according to claim 2 comprising hot water sensors which are connectable to the processor for providing information about hot water conditions to the processor whereby, the information about hot water conditions is compared to planned information and/or dynamic information and adjustments made accordingly.

6. The control system according to claim 2 comprising: a server having planned information; a man to machine interface capable of communication with the server to provide dynamic information; a processor which is capable of communication with at least the server and receiving signals therefrom; and at least one room node connectable to the processor for providing information about conditions within the room to the processor whereby, the information about room conditions is compared to planned information and/or dynamic information and permitting adjustments to be made accordingly.

7. The control system according to claim 6 wherein, the room node comprises sensors which provide information about conditions in the room.

8. The control system according to claim 6 wherein, planned information is provided by an electronically stored calendar.

9. The control system according to claim 5 wherein, dynamic information includes one or more of changes to planned occupancy; the effect of solar heating; and the effect of weather conditions.

10. The control system according to claim 9 wherein changes to planned occupancy is established through one or more of detecting location of a user; detecting destination of a user; and calculating estimated time of arrival (ETA) of a user.

11. The control system according to claim 10 wherein location of a user can be established internally using one or more room sensors or externally using the man to machine interface.

12. A method of controlling a (HVAC) system for a building utilizing the control system of claim 1 comprising the steps of: providing information relating to planned use of the building; and updating this information based on dynamic information including user location, user destination, estimated time of arrival of a user, weather conditions, solar radiation effect, user input information and sensor information related to the building.

13. (canceled)

14. (canceled)
